(19) United States
(12) Patent Application Publication
(10) Pub. No.: US 2007/0089685 A1
(43) Pub. Date: Apr. 26, 2007

(54) Housing system for animals

(76) Inventors: Alison Gottlieb, Cedar Grove, NJ (US); Jessica Kerr, Clifton, NJ (US)

Correspondence Address: COZEN O'CONNOR, P.C., 1900 MARKET STREET, PHILADELPHIA, PA, 19103-3508, US

(21) Appl. No.: 11/259,320

(22) Filed: Oct. 26, 2005

(51) Int. Cl. A01K 1/03

(52) U.S. Cl. 119/497

(57) ABSTRACT

A housing system for an animal such as a cat comprising translucent or colored walls to allow observation but to inhibit the animal from viewing surroundings outside the housing is disclosed. The housing has a wall which is movable toward the opposing wall for restraining the animal during a procedure such as an injection through an opening in one of the walls. The housing is sized so as to fit within a conventional veterinary cage for the corresponding animal. The housing has a wall or section of a wall which can be removed or opened for entry or removal of the animal.

### BACKGROUND OF THE INVENTION

This invention relates to housings for animals.

During veterinary procedures, animals are generally housed in wire cages from which the animal can easily view its surroundings. Cats and other animals can become very stressed or fractious from the sight of neighboring animals or humans outside the cage in such settings. For a veterinarian or other animal health professional, calming and restraining a scared, stressed, or fractious animal for a procedure such as an inoculation can be very difficult.

A conventional wire cage for animals is disclosed by Yellin in U.S. Pat. No. 3,742,909. A cleanable observation cage for reptiles with a transparent front wall is disclosed by Itzak in U.S. Pat. No. 5,794,567. A pet enclosure having a temperature controlled air delivery system is disclosed by Fekete in U.S. Pat. No. 6,047,662.

A known method for calming nervous animals in a veterinary or kennel setting is cut up a cardboard box so that the animal can find a calming sanctuary inside. It is also known to wear protective gloves and/or clothing to prevent a nervous animal from biting or scratching a handler or veterinarian attempting to perform a veterinary procedure.

There is a need in the field of veterinary medicine to provide a system for a housing system which allows observation from the outside but inhibits an animal from viewing its surroundings outside the housing. There is also a need for a housing system which allows a veterinarian or animal health provider to temporarily restrain an animal still during a procedure such as an inoculation.

### SUMMARY OF THE INVENTION

These needs, and others which will become apparent from the following detailed disclosure and the drawings, are met by the present invention which comprises in one aspect a housing system for small animal comprising a top wall, bottom wall, front wall, back wall, left side wall, and right side wall, at least one of the top, front, back, left side, and right side walls having a removable section, at least one of the top, front, back, left side, and right side walls being translucent, reflective, and/or colored so that an animal within the housing can be observed from outside the housing but so that the animal can not a person observing from the outside; one of the walls being movable toward the opposing wall so as to temporarily reduce the internal space within the housing and thereby temporarily restrain a small animal within the housing against an opposing wall during a medical procedure, and one or more injection openings in one or more walls through which a temporarily restrained animal can be injected.

The removable section is preferably within one of the side walls and the moveable wall is preferably the opposing side wall. The removable section can be hinged or can be a panel which slides in via grooves in the side wall, or it can be any other type of arrangement which allows it to be removed so that an animal can enter or exit the housing. The moveable wall can be supported by guides such as acrylic rods, for example, so that it can slide in and out so as to force a confined animal into a smaller volume and inoculation or injection through an injection hole in one of the walls. The moveable wall preferably has a handle for use during sliding the wall in or out.

At least one of the walls, and preferably at least the front wall, is constructed of translucent or colored plastic or glass. The translucency or color is selected to reduce the ability of the animal to see outside the housing while at the same time permitting a person to see the animal. The inability to see out by the animal results in the animal becoming calm and not being frightened by the surrounding animals, people, or objects outside the housing.

A handle, for example on the top wall, is an optional feature which permits the housing system to function as an animal carrier. In this configuration the housing can be used to transport a pet to the veterinarian or, with the front panel removed, can be used as an animal bed or play box.

Some animals, for example cats, become very stressed in hospital environments and hide under blankets. The animals may not eat and they may become paralyzed with fear, which is detrimental to the healing process in the case of ill animals.

### BRIEF DESCRIPTION OF THE DRAWINGS

FIG. 1 is a front perspective view of a housing system embodiment according to the invention.

FIG. 2 is rear perspective view of the housing system of FIG. 1, according to the invention.

FIG. 3 is a side plan view of the housing system embodiment of FIG. 1 according to the invention.

FIG. 4 is a front elevation view of a movable door member of the housing system embodiment of FIG. 1, according to the invention.

### DETAILED DESCRIPTION

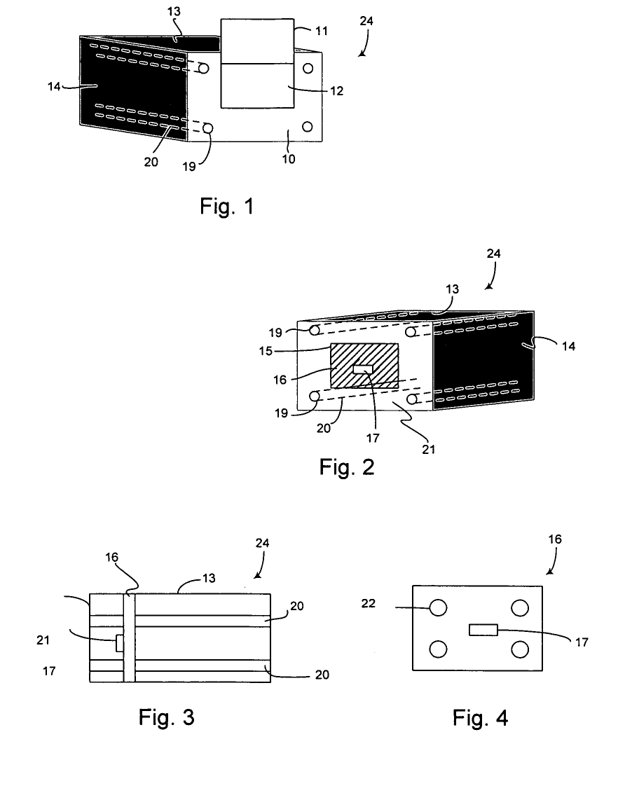

FIG. 1 illustrates an embodiment of the invention wherein a housing system 24 for an animal has a top wall 13, left side wall 14, front wall 10, and a bottom and rear wall which are not visible in this view. A removable section 11 in front wall 10 fits in grooves (not shown) in the front wall 10 and can be slid up or down to form an opening 12 or to close the opening 12 within the front wall 10. The opening 12 is used to remove or insert an animal into the housing and the removable section 11 is used to close the opening 12 to keep the animal inside the housing system.

The top wall 13, left side wall 14, front wall 10, bottom wall, rear wall, and removable section in this embodiment are all constructed of 0.25 inch thick smoked gray acrylic sheet. The smoked gray color has been found to have a calming effect on cats and also inhibits the ability of a cat to see outside the housing while at the same time does not prevent a person from viewing the animal from outside the housing. Other translucent, reflective, and/or colored materials such as plastics or glass can be used as long as they also have the calming effect, reduce the ability of the animal to see outside while also permitting a person to view a housed animal from the outside.

One or more holes 23 are provided so that the animal can be inoculated or injected, for example with a sedative prior to an operation or other medical procedure. The holes 23 proved ventilation. The holes can also be used for nebulization and oxygenation.

Acrylic guide rods 20 having ends 19 secured to or in front wall 10 and rear wall 21 (FIG. 2) are provided to support and guide a moveable wall 16 (FIG. 2).

Referring now to FIG. 2, the housing system 24 has a rear wall 21 into which the ends 19 of guide rods 20 are supported, either by an adhesive bond or by fitting the ends 19 snugly into corresponding openings in rear wall 21. An alternative way to secure the guide rods to the end walls would be to use a screw through rear wall 21 into rod 20 through its end 19 and other screws through each wall, and each end of each rod. An opening 15 in rear wall 21 is provided. Through opening 15, movable wall 16 is illustrated with cross-hatching. Movable wall 16 has a handle 17. Using the handle 17, a person can move the wall 16 toward the front of the housing by reaching through opening 16.

Referring to FIG. 3, the movable wall 16 is shown in a position one quarter of the way from the rear to the front. Handle 17 can be reached through opening 15 in rear wall 21.

Referring to FIG. 4, movable wall 16 has four holes 22 which are slightly larger than guide rods 20 (FIG. 3). The movable wall 16 is supported by rods 20 which are in turn supported by front wall 10 and rear wall 21. The four guide rods 20 are parallel to each other and are of the same length. The wall rides on the guide rods and the guide rods keep the wall in a vertical position parallel to the front 10 and rear 21 end walls.

In practice, an animal can be placed in the housing through opening 12 when the door 11 is removed or opened, and then restrained in the housing when the door 11 is closed. The coloring in the walls keeps the animal calm and prevents it from seeing outside the housing. The animal can be viewed from the outside through any of the walls. The movable door 16 is operated by holding handle 17 and is pushed toward the front so as to reduce the volume of the housing and push the animal toward the front when it must be restrained for a procedure such as an inoculation or injection through one of the injection holes 23, or the moveable wall can be used to push the animal out of the housing through opening 15 when the door 11 is open or removed.

The preferred dimensions of the housing are about 15 to 17″ wide, about 14″ deep, and about 14″ wide, which allows the housing to fit within conventional veterinary cages, and is also a convenient size for carrying the animal outside of veterinary environments.

While the invention has been illustrated and described in detail in the drawings and the forgoing description, such is considered to be illustrative and not restrictive in character. Various alternatives, modifications, and improvements should become readily apparent to those skilled in this art without departing from the spirit and scope of the invention.

1. A housing system for a small animal comprising
a top wall, bottom wall, front wall, back wall, left side wall, and right side wall, at least one of the top, front, back, left side, and right side walls having a removable section, at least one of the top, front, back, left side, and right side walls being translucent, reflective, and/or colored, selected to reduce the ability of the animal to see outside the housing while at the same time permitting a person to see the animal
a movable wall vertical wall which can be moved in a horizontal direction so as to temporarily reduce the internal space within the housing and thereby temporarily restrain a small animal within the housing against an opposing wall during a medical procedure, and
one or more injection openings in one or more walls through which a temporarily restrained animal can be injected.

2. The system of claim 1 further including a carying handle.

3. The system of claim 1 wherein the removable section is within a first side wall and the movable wall is the second, opposing side wall.

4. The system of claim 1 wherein at least one of the front, side, and top walls is constructed of translucent plastic sheet.

5. The system of claim 1 wherein the removable section is a panel within one of the walls which can be slid in and out.

6. The system of claim 1 wherein the housing is about 15 to 17 inches wide, about 14 inches high and about 14 inches deep.

7. The system of claim 1 wherein the housing has a width, depth, and height, each of which are less than the corresponding width, depth, and height of a conventional veterinary cage so as to allow placing of the housing within the conventional veterinary cage.

8. The system of claim 1 wherein each of the walls and the removable section are constructed of colored acrylic sheet.

9. The system of claim 1 wherein each of the walls is constructed of gray translucent acrylic sheet.

10. A method of restraining an animal during a veterinary procedure comprising providing a housing system of claim 1, moving the moveable wall toward the opposing wall so as to reduce the volume of space available to the animal within the housing so that the animal can not move about within the housing, and inoculating the animal through an opening in one of the walls.

11. The method of claim 10 further including placing the housing within a conventional veterinary cage.
